(19) United States
(12) Patent Application Publication
(10) Pub. No.: US 2024/0296462 A1
(43) Pub. Date: Sep. 5, 2024

(54) METHOD AND SYSTEM FOR ALGORITHMIC BIAS EVALUATION OF RISK ASSESSMENT MODELS

(71) Applicant: JPMorgan Chase Bank, N.A., New York, NY (US)

(72) Inventors: Suneetha VAKALAPUDI, Garnet Valley, PA (US); Ramana NALLAJARLA, Hockessin, DE (US); Satish Kumar KAKARA, Lewis Center, OH (US); Gangadhar GOLLA, Hyderabad (IN); Waseem Minhaj, Newark, DE (US)

(73) Assignee: JPMorgan Chase Bank, N.A., New York, NY (US)

(21) Appl. No.: 18/392,986

(22) Filed: Dec. 21, 2023

(30) Foreign Application Priority Data
Mar. 3, 2023 (IN) 202311014533

(51) Int. Cl. G06Q 30/018

(52) U.S. Cl. CPC G06Q 30/018

(57) ABSTRACT

A method, system, and computer-readable storage medium storing instructions, for assessing biases of a risk assessment model. The method, system, and computer-readable storage medium storing instructions, comprising: receiving, by a processor, a first model; generating, by the processor, a first model score output file by evaluating the first model; transmitting, by the processor, the first model score output file to a disparate impact analysis (DIA) service; utilizing, by the processor, the DIA service to obtain, from a government monitoring information (GMI) database, first GMI data that corresponds to a first set of ethics and compliance initiative (ECI) information; further utilizing, by the processor, the DIA service to calculate first DIA results by analyzing the first set of ECI information and the first GMI data; and determining, based on the first DIA results, whether any features of the first model exceed at least one predetermined threshold.

### CROSS-REFERENCE TO RELATED APPLICATIONS

This application claims priority benefit from Indian application Ser. No. 20/231,1014533, filed Mar. 3, 2023, which is hereby incorporated by reference in its entirety.

### BACKGROUND

### 1. Field of the Invention

The field of the invention disclosed herein generally relates to a system for assessing biases of a risk assessment model and, more particularly, to a method, system, and computer-readable storage medium storing instructions, for assessing biases of artificial intelligence/machine learning (AI/ML) risk assessment models in a manner that enables efficient review of a large set of models.

### 2. Background of the Invention

For some time now, the Office of Fair Lending (OFL) has been tasked with the primary responsibility of reviewing various line of business (LOB) models for compliance with fair lending laws and regulatory expectations. The OFL reviews models for any model bias with respect to any prohibited basis, such as race, ethnicity, sex, age, etc. However, although regulations may actually require a quantitative review of every regulated model, it is only practical for conventional technological systems to provide an in-depth, quantitative review (e.g., disparate impact analysis, substitution analysis, or both) of models that have the highest fair lending risks. For example, regulators expect every LOB model that impacts consumer credit (such as underwriting, pricing, account management, marketing, etc.) to be reviewed for lending risks.

In addition to this, there has been a growing focus on model bias, including fairness in the provision of financial products and services beyond credit and, although the focus on model bias has been increasing in recent years, this trend has accelerated over the past year due to both the increasing market adoption of AI/ML models and a growing focus on fairness and racial justice. Therefore, due to this increased focus on fairness, racial justice, and model bias, a new way of reviewing models for bias is required in order to enable a large set of models to be reviewed efficiently.

### SUMMARY

The present disclosure, through one or more of its various aspects, embodiments, and/or specific features or sub-component, provides, inter alia, various systems, servers, devices, methods, media, programs and platforms for assessing biases of a risk assessment model.

According to an aspect of the present disclosure, a method is provided for assessing biases of a risk assessment model. The method may comprise: receiving, by a processor, a first model; generating, by the processor, a first model score output file by evaluating the first model; transmitting, by the processor, the first model score output file to a disparate impact analysis (DIA) service; utilizing, by the processor, the DIA service to obtain, from a government monitoring information (GMI) database, first GMI data that corresponds to a first set of ethics and compliance initiative (ECI) information; further utilizing, by the processor, the DIA service to calculate first DIA results by analyzing the first set of ECI information and the first GMI data; and determining, based on the first DIA results, whether any features of the first model exceed at least one predetermined threshold. The first model score output file may comprise the first set of ECI information, and the first DIA results may comprise a first bias distribution of the first model.

The method may further comprise: determining that none of the features of the first model exceeds the at least one predetermined threshold; after a predetermined period of time, utilizing, by the processor, the DIA service to obtain, from the GMI database, second GMI data that corresponds to the first set of ECI information; further utilizing, by the processor, the DIA service to calculate second DIA results by analyzing the first set of ECI information and the second GMI data; and determining, based on the second DIA results, whether any features of the first model exceed the at least one predetermined threshold. The second DIA results comprise a second bias distribution of the first model.

The method may further comprise: after a determination of whether any of the features of the first model exceed the at least one predetermined threshold, storing, by the processor, the first DIA results in a DIA results database; and displaying, by the processor, the first DIA results on a dashboard by accessing the DIA results database. The first DIA results may further comprise the determination of whether any features of the first model exceed the at least one predetermined threshold.

In the method, the displaying the first DIA results on the dashboard may comprise: displaying, within at least one graph, the first bias distribution of the first model. The at least one graph may provide at least one indication of the determination of whether any features of the first model exceed the at least one predetermined threshold.

The method may further comprise further utilizing, by the processor, the DIA service to: determine that at least one of the features of the first model exceeds the at least one predetermined threshold; and generate at least one recommended change for adjusting the at least one of the features of the first model, to fall within the at least one predetermined threshold.

In the method, the processor may include an artificial intelligence feature that utilizes a machine learning model to generate the at least one recommended change for adjusting the at least one of the features of the first model.

The method may further comprise: generating, by the processor, an updated version of the first model by retraining the first model according to the at least one recommended change; generating, by the processor, an updated first model score output file by evaluating the updated version of the first model; transmitting, by the processor, the updated first model score output file to the DIA service; utilizing, by the processor, the DIA service to calculate updated DIA results by analyzing an updated set of ECI information and the first GMI data; and determining, based on the updated DIA results, whether any features of the updated version of the first model exceed the at least one predetermined threshold. The updated first model score output file may comprise the updated set of ECI information, and the updated DIA results may comprise an updated bias distribution of the updated version of the first model.

The method may further comprise: determining that none of the features of the updated version of the first model exceeds the at least one predetermined threshold; after a predetermined period of time, obtaining, from the GMI database, second GMI data that corresponds to the updated set of ECI information; further utilizing, by the processor, the DIA service to calculate second DIA results by analyzing the updated set of ECI information and the second GMI data; and determining, based on the second DIA results, whether any features of the updated version of the first model exceeds the at least one predetermined threshold. The second DIA results may comprise a second bias distribution of the updated version of the first model.

The method may further comprise further utilizing, by the processor, the DIA service to: determine that at least one of the features of the updated version of the first model exceeds the at least one predetermined threshold; and generate at least one additional recommended change for adjusting the at least one of the features of the updated version of the first model, to fall within the at least one predetermined threshold.

The method may further comprise: updating, by the processor, a machine learning model of the processor by retraining the machine learning model to indicate that the at least one recommended change does not adjust the at least one of the features of the first model to fall within the at least one predetermined threshold. The updating may retrain the machine learning model to indicate that the at least one recommended change does not adjust the at least one of the features of the first model to fall within the at least one predetermined threshold.

According to another aspect of the present disclosure, a system is provided for assessing biases of a risk assessment model. The system may comprise: a processor; and memory storing executable instructions. The executable instructions, when executed by the processor, may configure the processor to: receive a first model; generate a first model score output file by evaluating the first model,; transmit the first model score output file to a disparate impact analysis (DIA) service; utilize the DIA service to: obtain, from a government monitoring information (GMI) database, first GMI data that corresponds to a first set of ethics and compliance initiative (ECI) information; and calculate first DIA results by analyzing the first set of ECI information and the first GMI data; and determine, based on the first DIA results, whether any features of the first model exceed at least one predetermined threshold. The first model score output file may comprise the first set of ECI information, and the first DIA results may comprise a first bias distribution of the first model.

In the system, the executable instructions may further configure the processor to: determine that none of the features of the first model exceeds the at least one predetermined threshold; after a predetermined period of time, further utilize the DIA service to: obtain, from the GMI database, second GMI data that corresponds to the first set of ECI information; and calculate second DIA results by analyzing the first set of ECI information and the second GMI data; and determine, based on the second DIA results, whether any features of the first model exceed the at least one predetermined threshold. The second DIA results may comprise a second bias distribution of the first model.

In the system, the executable instructions may further configure the processor to: after a determination of whether any of the features of the first model exceed the at least one predetermined threshold, store the first DIA results in a DIA results database; and display the first DIA results on a dashboard by accessing the DIA results database. The first DIA results may further comprise the determination of whether any features of the first model exceed the at least one predetermined threshold.

In the system, the display of the first DIA results on the dashboard may comprise: displaying, within at least one graph, the first bias distribution of the first model. The at least one graph may provide at least one indication of the determination of whether any features of the first model exceed the at least one predetermined threshold.

In the system, the executable instructions may further configure the processor to utilize the DIA service to: determine that at least one of the features of the first model exceeds the at least one predetermined threshold; and generate at least one recommended change for adjusting the at least one of the features of the first model, to fall within the at least one predetermined threshold.

In the system, the processor may include an artificial intelligence feature that utilizes a machine learning model to generate the at least one recommended change for adjusting the at least one of the features of the first model.

In the system, the executable instructions may further configure the processor to: generate an updated version of the first model by retraining the first model according to the at least one recommended change; generate an updated first model score output file by evaluating the updated version of the first model; transmit the updated first model score output file to the DIA service; utilize the DIA service to calculate updated DIA results by analyzing the updated set of ECI information and the first GMI data; and determine, based on the updated DIA results, whether any features of the updated version of the first model exceed the at least one predetermined threshold. The updated first model score output file may comprise an updated set of ECI information, and the updated DIA results may comprise an updated bias distribution of the updated version of the first model.

In the system, the executable instructions may further configure the processor to: determine that none of the features of the updated version of the first model exceeds the at least one predetermined threshold; after a predetermined period of time, obtain, from the GMI database, second GMI data that corresponds to the updated set of ECI information; utilize the DIA service to calculate second DIA results by analyzing the updated set of ECI information and the second GMI data; and determine, based on the second DIA results, whether any features of the updated version of the first model exceeds the at least one predetermined threshold. The second DIA results may comprise a second bias distribution of the updated version of the first model

In the system, the executable instructions may further configure the processor to utilize the DIA service to: determine that at least one of the features of the updated version of the first model exceeds the at least one predetermined threshold; and generate at least one additional recommended change for adjusting the at least one of the features of the updated version of the first model, to fall within the at least one predetermined threshold.

In the system, the executable instructions may further configure the processor to: update a machine learning model of the processor by retraining the machine learning model to indicate that the at least one recommended change does not adjust the at least one of the features of the first model to fall within the at least one predetermined threshold.

According to yet a further aspect of the present disclosure, a non-transitory computer readable medium storing executable instructions, is provided for assessing biases of a risk assessment model. The executable instructions, when executed by a processor, may configure the processor to: receive a first model; generate a first model score output file by evaluating the first model; transmit the first model score output file to a disparate impact analysis (DIA) service; utilize the DIA service to: obtain, from a government monitoring information (GMI) database, first GMI data that corresponds to a first set of ethics and compliance initiative (ECI) information; and calculate first DIA results by analyzing the first set of ECI information and the first GMI data; and determine, based on the first DIA results, whether any features of the first model exceed at least one predetermined threshold. The first model score output file may comprise the first set of ECI information, and the first DIA results comprise a first bias distribution of the first model.

In the non-transitory computer readable medium, the executable instructions may further configure the processor to: determine that none of the features of the first model exceeds the at least one predetermined threshold; after a predetermined period of time, further utilize the DIA service to: obtain, from the GMI database, second GMI data that corresponds to the first set of ECI information; and calculate second DIA results by analyzing the first set of ECI information and the second GMI data; and determine, based on the second DIA results, whether any features of the first model exceed the at least one predetermined threshold. The second DIA results may comprise a second bias distribution of the first model.

In the non-transitory computer readable medium, the executable instructions may further configure the processor to: after a determination of whether any of the features of the first model exceed the at least one predetermined threshold, store the first DIA results in a DIA results database; and display the first DIA results on a dashboard by accessing the DIA results database. The first DIA results may further comprise the determination of whether any features of the first model exceed the at least one predetermined threshold.

In the non-transitory computer readable medium, the display of the first DIA results on the dashboard may comprise: displaying, within at least one graph, the first bias distribution of the first model. The at least one graph may provide at least one indication of the determination of whether any features of the first model exceed the at least one predetermined threshold.

In the non-transitory computer readable medium, the executable instructions may further configure the processor to utilize the DIA service to: determine that at least one of the features of the first model exceeds the at least one predetermined threshold; and generate at least one recommended change for adjusting the at least one of the features of the first model, to fall within the at least one predetermined threshold.

In the non-transitory computer readable medium, the processor may include an artificial intelligence feature that utilizes a machine learning model to generate the at least one recommended change for adjusting the at least one of the features of the first model.

In the non-transitory computer readable medium, the executable instructions may further configure the processor to: generate an updated version of the first model by retraining the first model according to the at least one recommended change; generate an updated first model score output file by evaluating the updated version of the first model; transmit the updated first model score output file to the DIA service; utilize the DIA service to calculate updated DIA results by analyzing the updated set of ECI information and the first GMI data; and determine, based on the updated DIA results, whether any features of the updated version of the first model exceed the at least one predetermined threshold. The updated first model score output file may comprise an updated set of ECI information, and the updated DIA results may comprise an updated bias distribution of the updated version of the first model.

In the non-transitory computer readable medium, the executable instructions may further configure the processor to: determine that none of the features of the updated version of the first model exceeds the at least one predetermined threshold; after a predetermined period of time, obtain, from the GMI database, second GMI data that corresponds to the updated set of ECI information; utilize the DIA service to calculate second DIA results by analyzing the updated set of ECI information and the second GMI data; and determine, based on the second DIA results, whether any features of the updated version of the first model exceeds the at least one predetermined threshold. The second DIA results may comprise a second bias distribution of the updated version of the first model

In the non-transitory computer readable medium, the executable instructions may further configure the processor to utilize the DIA service to: determine that at least one of the features of the updated version of the first model exceeds the at least one predetermined threshold; and generate at least one additional recommended change for adjusting the at least one of the features of the updated version of the first model, to fall within the at least one predetermined threshold.

In the non-transitory computer readable medium, the executable instructions may further configure the processor to: update a machine learning model of the processor by retraining the machine learning model to indicate that the at least one recommended change does not adjust the at least one of the features of the first model to fall within the at least one predetermined threshold.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system for implementing an algorithmic bias evaluation service that assesses bias of risk assessment models in a manner that enables efficient review of a large set of models.

FIG. 2 illustrates an exemplary diagram of a network environment for implementing an algorithmic bias evaluation service that assesses bias of risk assessment models in a manner that enables efficient review of a large set of models.

FIG. 3 illustrates an exemplary system for implementing an algorithmic bias evaluation service that assesses bias of risk assessment models in a manner that enables efficient review of a large set of models.

FIG. 4 is a flowchart of an exemplary process for assessing biases of risk assessment models in a manner that enables efficient review of a large set of models.

FIG. 5 illustrates an exemplary model training system for implementing an algorithmic bias evaluation service that assesses bias of risk assessment models in a manner that enables efficient review of a large set of models.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable storage media having instructions stored thereon for one or more aspects of the present technology as described and illustrated by way of the examples herein. In some examples, the instructions include executable instructions that, when executed by one or more processors, cause the processors to carry out steps necessary to implement the methods of the examples of this technology that are described and illustrated herein.

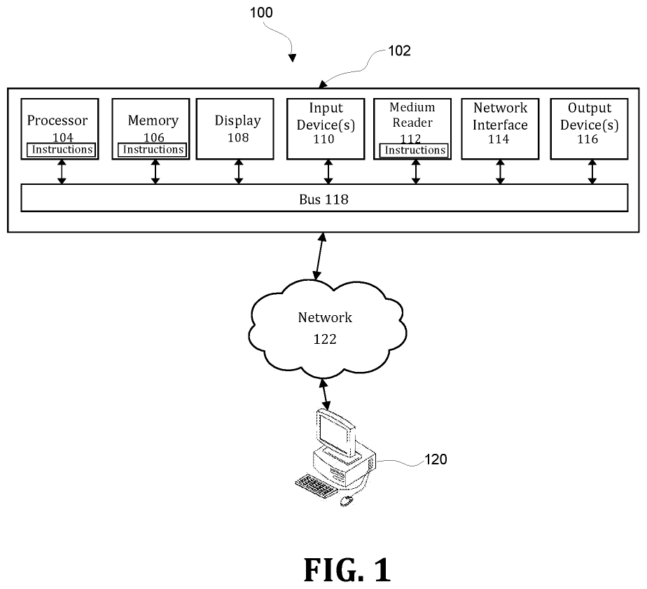

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for implementing an algorithmic bias evaluation service that improves the overall speed, ease, and user experience of code correction and code refactoring tasks.

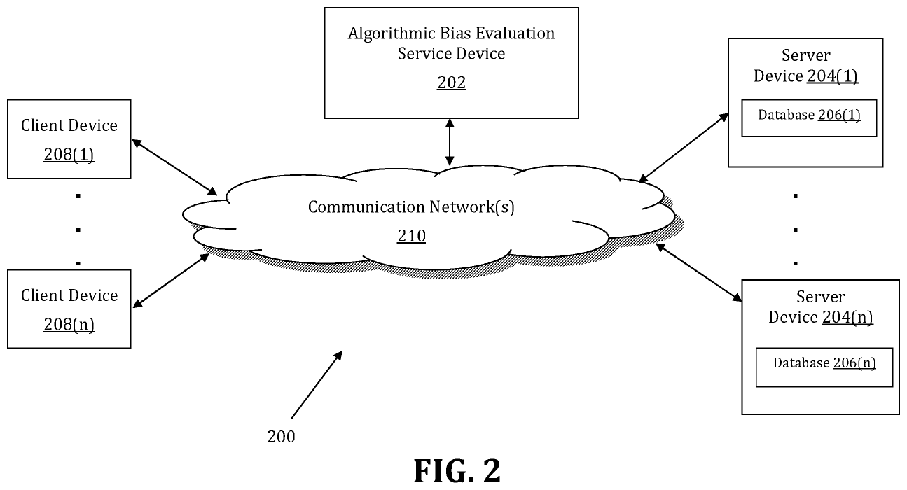

Referring to FIG. 2, a schematic of an exemplary network environment 200 for implementing an algorithmic bias evaluation service that assesses bias of risk assessment models in a manner that enables efficient review of a large set of models, is illustrated. In an exemplary embodiment, the method is executable on any networked computer platform, such as, for example, a personal computer (PC).

The method for implementing an algorithmic bias evaluation service may be implemented by algorithmic bias evaluation service (ABES) device 202. The ABES device 202 may be the same or similar to the computer system 102 as described with respect to FIG. 1. The ABES device 202 may be a rack-mounted server in a datacenter, an embedded microcontroller (MCU) in an electronic device, or another type of headless system, which is a computer system or device that is configured to operate without a monitor, keyboard and mouse. The ABES device 202 may store one or more applications that can include executable instructions that, when executed by the ABES device 202, cause the ABES device 202 to perform actions, such as to transmit, receive, or otherwise process network communications, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the ABES device 202 itself, may be located in virtual server(s) running in a cloud-based computing environment rather than being tied to one or more specific physical network computing devices. Also, the application(s) may be running in one or more virtual machines (VMs) executing on the ABES device 202. Additionally, in one or more embodiments of this technology, virtual machine(s) running on the ABES device 202 may be managed or supervised by a hypervisor.

In the network environment 200 of FIG. 2, the ABES device 202 is coupled to a plurality of server devices 204(1)-204(n) that hosts a plurality of databases 206(1)-206(n), and also to a plurality of client devices 208(1)-208(n) via communication network(s) 210. A communication interface of the ABES device 202, such as the network interface 114 of the computer system 102 of FIG. 1, operatively couples and communicates between the ABES device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the ABES device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, computer readable media, and ABES devices that efficiently implement a method for an algorithmic bias evaluation service that assesses bias of risk assessment models in a manner that enables efficient review of a large set of models.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The ABES device 202 may be a standalone device or integrated with one or more other devices or apparatuses, such as one or more of the server devices 204(1)-204(n), for example. In one particular example, the ABES device 202 may include or be hosted by one of the server devices 204(1)-204(n), and other arrangements are also possible. As another example, the ABES device 202 may be integrated with one or more other devices or apparatuses, such as one or more of the client devices 208(1)-208(n). Moreover, one or more of the devices of the ABES device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the ABES device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to an application code repository and a machine learning model repository.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the ABES device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the ABES device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the ABES device 202, the server devices 204(1)-204(n), the databases 206(1)-206(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the ABES device 202, the server devices 204(1)-204(n), the databases 206(1)-206(n), or the client devices 208(1)-208(n), for example, may be configured to operate as virtual instances on the same physical machine. In other words, one or more of the ABES device 202, the server devices 204(1)-204(n), the databases 206(1)-206(n), or the client devices 208(1)-208(n) may operate on the same physical device rather than as separate devices communicating through communication network(s) 210. Additionally, there may be more or fewer ABES devices 202, server devices 204(1)-204(n), databases 206(1)-206(n), or client devices 208(1)-208(n) than illustrated in FIG. 2.

In addition, two or more computing systems, databases or devices may be substituted for any one of the systems, databases or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

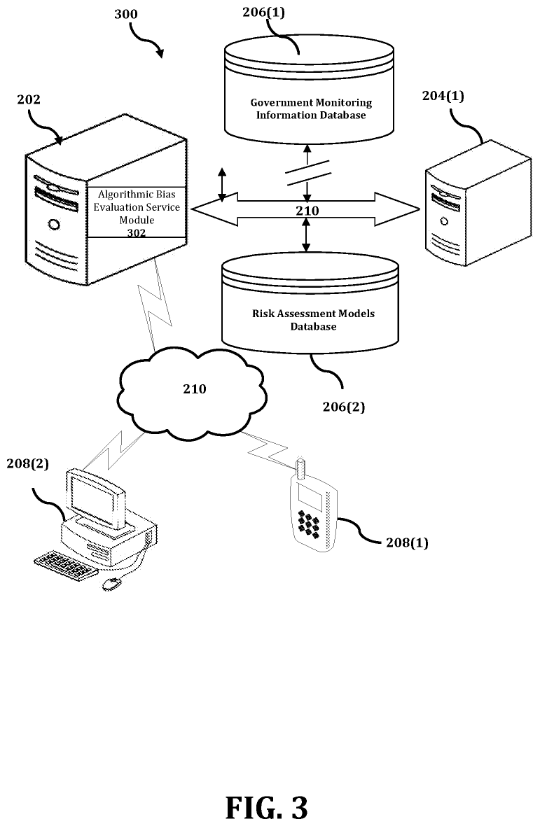

The ABES device 202 is described and illustrated in FIG. 3 as including algorithmic bias evaluation service module 302, although it may include other rules, policies, modules, databases, or applications, for example. As will be described below, algorithmic bias evaluation service module 302 is configured to implement a method implementing an algorithmic bias evaluation service that assesses bias of risk assessment models in a manner that enables efficient review of a large set of models. Algorithmic bias evaluation service module 302 may include software that is based on a microservices architecture. Algorithmic bias evaluation service module 302 may also include artificial intelligence and/or machine learning functionality. This artificial intelligence and/or machine learning functionality may be based on a proprietary software application, some other application (e.g., Aurthur.AI and/or Fiddler.AI), or both.

Algorithmic bias evaluation service module 302 may be integrated with one or more devices or apparatuses, such as client devices 208(1)-208(n), where algorithmic bias evaluation service module 302 may be implemented as an application or as an addon or plugin to another application of the one or more devices or apparatuses, and where algorithmic bias evaluation service module 302 may execute in the background.

An exemplary process 300 for implementing an algorithmic bias evaluation service by utilizing the network environment of FIG. 2 is illustrated as being executed in FIG. 3. Specifically, a first client device 208(1) and a second client device 208(2) are illustrated as being in communication with ABES device 202. In this regard, the first client device 208(1) and the second client device 208(2) may be “clients” of the ABES device 202 and are described herein as such. Nevertheless, it is to be known and understood that the first client device 208(1) and/or the second client device 208(2) need not necessarily be “clients” of the ABES device 202, or any entity described in association therewith herein. Any additional or alternative relationship may exist between either or both of the first client device 208(1) and the second client device 208(2) and the ABES device 202, or no relationship may exist.

Further, ABES device 202 is illustrated as including algorithmic bias evaluation service module 302 and as being able to access government monitoring information (GMI) database 206(1), and risk assessment models database 206(2). However, ABES device 202 may also include a DIA service and, although algorithmic bias evaluation service module 302 may communicate directly with risk assessment models database 206(2), it should be noted that algorithmic bias evaluation service module 302 can only access GMI database 206(1) by utilizing a DIA service (such as the DIA service comprised in ABES device 202) as a proxy or intermediary. Nevertheless, algorithmic bias evaluation service module 302 may be configured to directly or indirectly access these databases in order to implement an algorithmic bias evaluation service that assesses bias of risk assessment models in a manner that enables efficient review of a large set of models.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The client devices 208(1)-208(n) may represent, for example, computer systems of an organization or database network. The first client device 208(1) represent, for example, one or more computer systems of a department or cluster within the organization or database network. Of course, the first client device 208(1) may include one or more of any of the devices described herein. The second client device 208(2) may be, for example, one or more computer systems of another department or cluster within the organization or database network. Of course, the second client device 208(2) may include one or more of any of the devices described herein.

The process may be executed via the communication network(s) 210, which may comprise plural networks as described above. For example, in an exemplary embodiment, either or both of the first client device 208(1) and the second client device 208(2) may communicate with the ABES device 202 via broadband or cellular communication. Of course, these embodiments are merely exemplary and are not limiting or exhaustive.

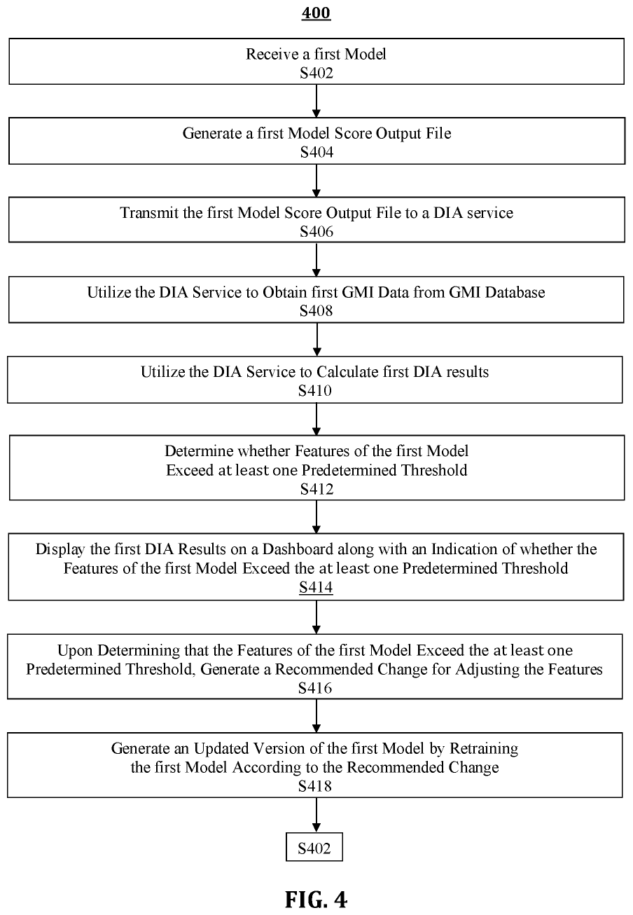

Algorithmic bias evaluation service module 302 may execute a process for implementing an algorithmic bias evaluation service that assesses bias of risk assessment models in a manner that enables efficient review of a large set of models. An exemplary process for implementing an algorithmic bias evaluation service is generally indicated at flowchart 400 in FIG. 4.

In process 400 of FIG. 4, at step S402, algorithmic bias evaluation service module 302 receives a first risk assessment model. The first risk assessment model may be received from an individual or any computer-readable medium, such as risk assessment models database 206(2). The first risk assessment model is a training data set that is comprised of one or more records The first risk assessment model may be an artificial intelligence model, a machine learning model, or both.

At step S404, algorithmic bias evaluation service module 302 generates a first model score output file by evaluating the first risk assessment model. The first model score output file may comprise a first set of ethics and compliance initiative (ECI) information, and each record in the first risk assessment model may be linked to ECI information. A first application programming interface (API) tool (e.g., a command line script that takes a model name and ID as input) may have been utilized to obtain the ECI information.

At step S406, algorithmic bias evaluation service module 302 transmits the first model score output file to a disparate impact analysis (DIA) service.

At step S408, algorithmic bias evaluation service module 302 utilizes the DIA service to obtain first GMI data from a GMI database, such as GMI database 206(1). GMI database 206(1) may be a grid-oriented storage (GOS) database. The first API tool or a second AIP tool may be utilized to obtain the GMI data. Also, the DIA service may utilize personally identifiable information of each record of a risk assessment model (such as the first risk assessment model) to search a GMI database for GMI data, and the resulting GMI data may be combined or, before they are combined, the resulting GMI data may be weighted according to the ownership weight of each recorded owner.

The first GMI data may be recorded in a customized GMI table, which is a table that is customized for a specific model (e.g., the first risk assessment model) so that the customized GMI table may store GMI data that corresponds to all ECI information of the specific model. The first GMI data may comprise data that has been encrypted according to any encryption standard (e.g., DES, AES, etc.) using either a different symmetric or asymmetric encryption key for every dataset (i.e., risk assessment model). However, the first GMI data may be kept confidential because users do not have access to this encryption key.

At step S410, algorithmic bias evaluation service module 302 utilizes the DIA service to calculate first disparate impact analysis (DIA) results that are based on the first GMI data.

Prior to having the DIA service calculate the first DIA results, ABES device 202 may anonymize or have the first risk assessment model, and any personally identifiable information (PII) therein, anonymized. The first risk assessment model may be anonymized by replacing its PII with a scramble key or a null value. However, each record of a risk assessment model (e.g., the first risk assessment model) may have already been anonymized before being stored in a risk assessment models database such as risk assessment model database 206(2) thus, under such circumstance, there will be no need to anonymize such a risk assessment model. Also, prior to calculating the first DIA results, the DIA service may decrypt the GMI data to calculate the first DIA results and, then, re-encrypt the GMI data to keep it confidential.

At step S412, algorithmic bias evaluation service module 302 determines whether features of the first risk assessment model exceed at least one predetermined threshold.

At step S414, algorithmic bias evaluation service module 302 displays the first DIA results along with an indication of which, if any, of the features of the first risk assessment model exceed the at least one predetermined threshold. Algorithmic bias evaluation service module 302 may display the first DIA results, along with the indication, in a presentation that is displayed on a dashboard. The indication may be provided by utilizing distinct colors to distinguish model features that exceed the at least predetermined threshold from those that do not. The dashboard may be depicted on a display, such as display 108, and the dashboard may also present the first DIA results via a graph or any other illustration that simplifies and clearly presents the first DIA results pictorially. At step S414, algorithmic bias evaluation service module 302 may also store the first DIA results in a DIA results database.

The model score output file may be presented to a modeler (or other user) in a display on a dashboard. However, the model score output file may be privileged data (i.e., non-public data that is legally or otherwise protected from disclosure) and shall be marked as such. Although the modeler (or other user) can view the model score output file, the modeler (or other user) cannot download or print the model score output file or its contents (e.g., the first bias distribution). Indeed, only an administrator (e.g., an approver from the OFL) may actually download the model score output file and its contents. Such an administrator may, then, store the model score output file and its contents along with any other relevant data. Every user of the technology disclosed herein may be identified according to login credentials that are unique to each user and required to log into the system disclosed herein (e.g., the system of ABES device 202). Thereby, ABES device 202 may generate an audit log on whoever accesses data of ABES device 202, which data is accessed, any action taken on the accessed data, and any other information relevant to the integrity of the data of ABES device 202.

Upon determining that the features of the first risk assessment model exceed the at least one predetermined threshold, at step S416, algorithmic bias evaluation service module 302 generates at least one recommended change for adjusting the features of the first risk assessment model, to fall within the at least one predetermined threshold. Algorithmic bias evaluation service module 302 may utilize artificial intelligence, a machine learning model, or both, to determine and generate the at least one recommended change for adjusting the features of the first risk assessment model. This artificial intelligence and/or machine learning model may be based on a proprietary software application, some other application (e.g., Aurthur.AI and/or Fiddler.AI), or both.

Upon determining that the features of a certain risk assessment model exceed the at least one predetermined threshold, at step S416, an artificial intelligence or machine learning model of algorithmic bias evaluation service module 302 may be updated by retraining the artificial intelligence or the machine learning model to indicate that the certain risk assessment model does not fall within the at least one predetermined threshold.

At step S418, algorithmic bias evaluation service module 302 generates an updated version of the first risk assessment model by retraining the first risk assessment model in response to the at least one recommended change for adjusting the features of the first risk assessment model. The updated version of the first risk assessment model may be based on the at least one recommended change. However, the updated version of the first risk assessment model may be based on an alternative course of action discerned by some other means (e.g., another automated device or software program, or an individual's recommendation, expertise and/or experience).

After step S418, process 400 returns to step S402, and the updated version of the first risk assessment model may be evaluated in the same manner as the first risk assessment model as per steps S402-S418. Indeed, steps S402-S418 of process 400 may be performed in sequence for a model and, then, repeated for any of that model's subsequent updates until algorithmic bias evaluation service module 302 determines that none of the features of the model, or its subsequent updates, exceeds the at least one predetermined threshold. After each determination of whether the features of the model, or its subsequent updates, exceed the at least one predetermined threshold, an artificial intelligence and/or machine learning model of algorithmic bias evaluation service module 302 may be updated by training the artificial intelligence, machine learning model, or both, to record whether the model, or one of its subsequent updates, falls within the at least one predetermined threshold.

Each result and every version of a risk assessment model may be linked to one another in storage by an identifier (ID), and retrieval of such data may be performed by specifying the desired result or version of the risk assessment model. Indeed, specifying the desired result or version may be achieved by specifying the date, time and/or file name of the result or version of the risk assessment model.

Upon determining that none of the features of any particular model exceeds the at least one predetermined threshold, after a predetermined amount of time, algorithmic bias evaluation service module 302 may utilize the DIA service to obtain second GMI data from the GMI database, then algorithmic bias evaluation service module 302 may utilize the DIA service to calculate second DIA results that are based on the second GMI data. Based on the second GMI data, algorithmic bias evaluation service module 302 may determine whether any features of the particular model exceed the at least one predetermined threshold. The second DIA results may be stored in the DIA results database and displayed in a presentation on a dashboard along with an indication of which, if any, of the features of the first risk assessment model exceeds at least one of the predetermined thresholds. The indication may be provided by utilizing distinct colors to distinguish model features that exceed the at least predetermined threshold from those that do not. The dashboard may be depicted on a display, such as display 108, and the dashboard may also present the first DIA results via a graph or any other illustration that simplifies and clearly presents the first DIA results pictorially

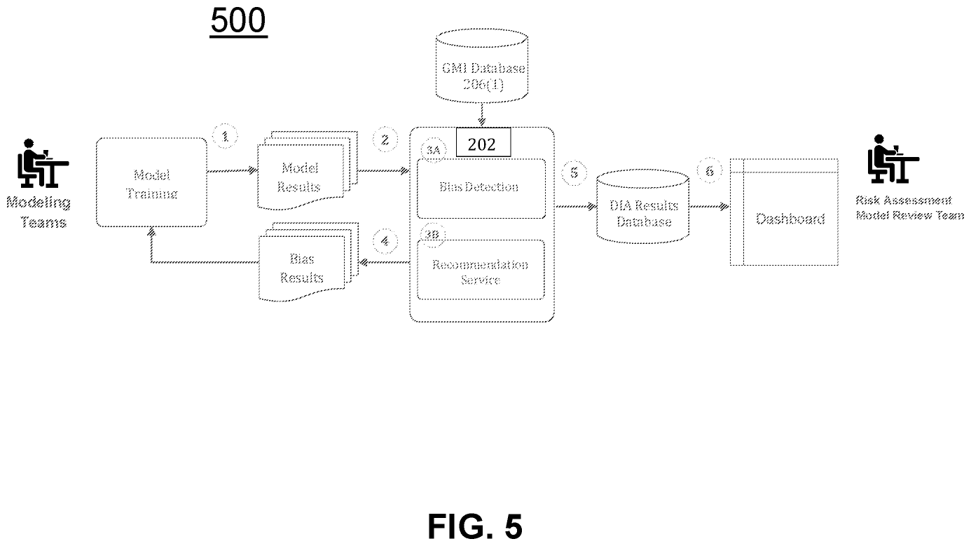

An exemplary system for applying an algorithmic bias evaluation service is generally depicted at an exemplary model training environment 500 in FIG. 5.

Model training environment 500 is an environment for training AI/ML models, such as AI/ML risk assessment models. Model training environment 500 comprises GMI database 206(1) and ABES device 202, for assessing biases of risk assessment models in a manner that enables efficient review of a large set of models. Model training environment 500 further comprises modeling teams that train risk assessment models and a risk assessment model review team that may be from the OFL or any other group that is tasked with ensuring that risk assessment models are not biased.

In model training environment 500, ABES device 202 may assess bias of risk assessment models according to the following steps.

At step 1, a modeler generates a model score output file for a first risk assessment model. The model score output file may include ethics and compliance initiative (ECI) information, and each record in the first risk assessment model may be linked to ECI information. An first application programming interface (API) tool (e.g., a command line script that takes a model name and ID as input) may have been utilized to obtain the ECI information. The modeler may be a member of a modeling team that is tasked with training AI/ML models. However, the modeler may also be an automated device or software program that is capable of training AI/ML models. Indeed, ABES device 202 may comprise the automated modeler.

At step 2, the modeler transmits the model score output file to a disparate impact analysis (DIA) service.

At step 3A, the DIA service reads a government monitoring information (GMI) database, such as GMI database 206(1), to retrieve first GMI data that corresponds to all the ECI information of the model score output file. GMI database 206(1) may be a grid-oriented storage (GOS) database. The first API tool or a second API tool be utilized to obtain the GMI data. Also, the DIA service may utilize personally identifiable information of each record of a risk assessment model to search a GMI database for GMI data, and the resulting GMI data may be combined or, before they are combined, the resulting GMI data may be weighted according to the ownership weight of each recorded owner. Then, based on the GMI data, at step 3A, the DIA service calculates first DIA results for the first risk assessment model. The first DIA results may include a first bias distribution for the first risk assessment model. A bias distribution (e.g., the first bias distribution) may be expressed as one or more percentages for each feature of a risk assessment model (e.g., the first risk assessment model).

Prior to having the DIA service calculate the first DIA results, ABES device 202 may anonymize or have the first risk assessment model, and any personally identifiable information (PII) therein, anonymized. The first risk assessment model may be anonymized by replacing its PII with a scramble key or a null value. Also, prior to calculating the first DIA results, the DIA service may decrypt the GMI data to calculate the first DIA results and, then, re-encrypt the GMI data in order to keep the GMI data confidential.

It should be noted that the first GMI data may be recorded in a customized GMI table, which is a table that is customized for a specific model (e.g., the first risk assessment model) so that the customized GMI table may store GMI data that corresponds to all ECI information of the specific model. It should also be noted that the first GMI data may comprise data that has been encrypted according to any encryption standard (e.g., DES, AES, etc.) using either a different symmetric or asymmetric encryption key for every dataset (i.e., risk assessment model). Therefore, the first GMI data may be kept confidential because users do not have access to this encryption key.

At step 3B, ABES device 202 utilizes the first DIA results to determine which of the first risk assessment model's features, if any, exceed one or more thresholds, which indicate whether a model (e.g., the first risk assessment model) is bias. Although ABES device 202 may utilize the DIA service to perform step 3B, it should be noted that, ABES device 202 may perform step 3B without utilizing the DIA service.

At step 4, the model score output file is transmitted to the modeler (or other user) for further analysis and, at step 5, the first DIA results are stored in a DIA results database. However, steps 4 and 5 are both optional as well as interchangeable. Every user of the system disclosed herein (e.g., ABES device 202) may be identified according to login credentials that are unique to each user and required to log into the system disclosed herein (e.g., the system of ABES device 202).

The model score output file may be presented to the modeler (or other user) in a display on a dashboard. However, the model score output file may be privileged data (i.e., non-public data that is legally or otherwise protected from disclosure) and shall be marked as such. Although the modeler (or other user) can view the model score output file, the modeler (or other user) cannot download or print the model score output file or its contents (e.g., the first bias distribution). Indeed, only an administrator (e.g., an approver from the risk model assessment review team) may actually download the model score output file and its contents. Such an administrator may, then, store the model score output file and its contents along with any other relevant data. Every user of the technology disclosed herein may be identified according to login credentials that are unique to each user and required to log into the system disclosed herein (e.g., the system of ABES device 202). Thereby, ABES device 202 may generate an audit log for whoever accesses data of ABES device 202, which data is accessed, any action taken on the accessed data, and any other information relevant to the integrity of the data of ABES device 202.

At step 6, risk assessment model review team or modeling leads, review the first DIA results that are stored in the DIA results database. Alternatively, this review may be performed by an automated device or software program, and the DIA results may be obtained from a source other than the DIA results database. For example, the first DIA results may be obtained directly from ABES device 202 for step 6's review. In addition, the first DIA results may be obtained from a display that is presented on a dashboard.

Accordingly, with this technology, a process for assessing biases of risk assessment models may be applied to a model training environment, such as model training environment 500, which may include one or more databases, such as the DIA results database and GMI database 206(1). Although model training environment 500 depicts a process that has been disclosed as being distinct from process 400, it should be noted that these two distinct processes may be performed either alternatively or in conjunction with one another.

Accordingly, the technological solution disclosed herein simplifies existing evaluation processes for risk assessment models and, thereby, reduces the time that it takes to evaluate such models for compliance as well as the cost of such evaluations. The technology disclosed herein improves existing technology in the field of the herein disclosed invention, by automating risk assessment model score calculations and risk assessment model score distribution determinations. This technological solution also improves on existing technology because its automated calculations and determinations tend to eliminate manual errors.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

1. A method for assessing biases of a risk assessment model, the method comprising:
receiving, by a processor, a first model;
generating, by the processor, a first model score output file by evaluating the first model, wherein the first model score output file comprises a first set of ethics and compliance initiative (ECI) information;
transmitting, by the processor, the first model score output file to a disparate impact analysis (DIA) service;
utilizing, by the processor, the DIA service to obtain, from a government monitoring information (GMI) database, first GMI data that corresponds to the first set of ECI information;
further utilizing, by the processor, the DIA service to calculate first DIA results by analyzing the first set of ECI information and the first GMI data, wherein the first DIA results comprise a first bias distribution of the first model; and
determining, based on the first DIA results, whether any features of the first model exceed at least one predetermined threshold.

2. The method of claim 1, further comprising:
determining that none of the features of the first model exceeds the at least one predetermined threshold;
after a predetermined period of time, utilizing, by the processor, the DIA service to obtain, from the GMI database, second GMI data that corresponds to the first set of ECI information;
further utilizing, by the processor, the DIA service to calculate second DIA results by analyzing the first set of ECI information and the second GMI data, wherein the second DIA results comprise a second bias distribution of the first model; and
determining, based on the second DIA results, whether any features of the first model exceed the at least one predetermined threshold.

3. The method of claim 1, further comprising:
after a determination of whether any of the features of the first model exceed the at least one predetermined threshold,
storing, by the processor, the first DIA results in a DIA results database, wherein the first DIA results further comprise the determination of whether any features of the first model exceed the at least one predetermined threshold; and
displaying, by the processor, the first DIA results on a dashboard by accessing the DIA results database.

4. The method of claim 3, wherein the displaying the first DIA results on the dashboard comprises:
displaying, within at least one graph, the first bias distribution of the first model, wherein the at least one graph provides at least one indication of the determination of whether any features of the first model exceed the at least one predetermined threshold.

5. The method of claim 1, further comprising:
further utilizing, by the processor, the DIA service to determine that at least one of the features of the first model exceeds the at least one predetermined threshold; and
generating, by the processor, at least one recommended change for adjusting the at least one of the features of the first model, to fall within the at least one predetermined threshold.

6. The method of claim 5, wherein the processor includes an artificial intelligence feature that utilizes a machine learning model to generate the at least one recommended change for adjusting the at least one of the features of the first model.

7. The method of claim 5, further comprising:
generating, by the processor, an updated version of the first model by retraining the first model according to the at least one recommended change;
generating, by the processor, an updated first model score output file by evaluating the updated version of the first model, wherein the updated first model score output file comprises an updated set of ECI information;
transmitting, by the processor, the updated first model score output file to the DIA service;
utilizing, by the processor, the DIA service to calculate updated DIA results by analyzing the updated set of ECI information and the first GMI data, wherein the updated DIA results comprise an updated bias distribution of the updated version of the first model; and
determining, based on the updated DIA results, whether any features of the updated version of the first model exceed the at least one predetermined threshold.

8. The method of claim 7, further comprising:
determining that none of the features of the updated version of the first model exceeds the at least one predetermined threshold;
after a predetermined period of time, obtaining, from the GMI database, second GMI data that corresponds to the updated set of ECI information;
further utilizing, by the processor, the DIA service to calculate second DIA results by analyzing the updated set of ECI information and the second GMI data, wherein the second DIA results comprise a second bias distribution of the updated version of the first model; and
determining, based on the second DIA results, whether any features of the updated version of the first model exceeds the at least one predetermined threshold.

9. The method of claim 7, further comprising:
further utilizing, by the processor, the DIA service to:
determine that at least one of the features of the updated version of the first model exceeds the at least one predetermined threshold; and
generate at least one additional recommended change for adjusting the at least one of the features of the updated version of the first model, to fall within the at least one predetermined threshold.

10. The method of claim 9, further comprising:
updating, by the processor, a machine learning model of the processor by retraining the machine learning model to indicate that the at least one recommended change does not adjust the at least one of the features of the first model to fall within the at least one predetermined threshold.

11. A system for assessing biases of a risk assessment model, the system comprising:
a processor; and
memory storing executable instructions that, when executed by the processor, configure the processor to:
receive a first model;
generate a first model score output file by evaluating the first model, wherein the first model score output file comprises a first set of ethics and compliance initiative (ECI) information;
transmit the first model score output file to a disparate impact analysis (DIA) service;
utilize the DIA service to:
obtain, from a government monitoring information (GMI) database, first GMI data that corresponds to the first set of ECI information; and
calculate first DIA results by analyzing the first set of ECI information and the first GMI data, wherein the first DIA results comprise a first bias distribution of the first model; and
determine, based on the first DIA results, whether any features of the first model exceed at least one predetermined threshold.

12. The system of claim 11, wherein the executable instructions further configure the processor to:
determine that none of the features of the first model exceeds the at least one predetermined threshold;
after a predetermined period of time, further utilize the DIA service to:
obtain, from the GMI database, second GMI data that corresponds to the first set of ECI information; and
calculate second DIA results by analyzing the first set of ECI information and the second GMI data, wherein the second DIA results comprise a second bias distribution of the first model; and
determine, based on the second DIA results, whether any features of the first model exceed the at least one predetermined threshold.

13. The system of claim 11, wherein the executable instructions further configure the processor to:
after a determination of whether any of the features of the first model exceed the at least one predetermined threshold, store the first DIA results in a DIA results database,
wherein the first DIA results further comprise the determination of whether any features of the first model exceed the at least one predetermined threshold; and
display the first DIA results on a dashboard by accessing the DIA results database.

14. The system of claim 13, wherein the display of the first DIA results on the dashboard comprises:
displaying, within at least one graph, the first bias distribution of the first model, wherein the at least one graph provides at least one indication of the determination of whether any features of the first model exceed the at least one predetermined threshold.

15. The system of claim 11, wherein the executable instructions further configure the processor to:
utilize the DIA service to determine that at least one of the features of the first model exceeds the at least one predetermined threshold; and
generate at least one recommended change for adjusting the at least one of the features of the first model, to fall within the at least one predetermined threshold.

16. The system of claim 15, wherein the executable instructions further configure the processor to:
generate an updated version of the first model by retraining the first model according to the at least one recommended change;
generate an updated first model score output file by evaluating the updated version of the first model, wherein the updated first model score output file comprises an updated set of ECI information;
transmit the updated first model score output file to the DIA service;
utilize the DIA service to calculate updated DIA results by analyzing the updated set of ECI information and the first GMI data, wherein the updated DIA results comprise an updated bias distribution of the updated version of the first model; and
determine, based on the updated DIA results, whether any features of the updated version of the first model exceed the at least one predetermined threshold.

17. The system of claim 16, wherein the executable instructions further configure the processor to:
determine that none of the features of the updated version of the first model exceeds the at least one predetermined threshold;
after a predetermined period of time, obtain, from the GMI database, second GMI data that corresponds to the updated set of ECI information;
utilize the DIA service to calculate second DIA results by analyzing the updated set of ECI information and the second GMI data, wherein the second DIA results comprise a second bias distribution of the updated version of the first model; and
determine, based on the second DIA results, whether any features of the updated version of the first model exceeds the at least one predetermined threshold.

18. The system of claim 16, wherein the executable instructions further configure the processor to utilize the DIA service to:
determine that at least one of the features of the updated version of the first model exceeds the at least one predetermined threshold; and
generate at least one additional recommended change for adjusting the at least one of the features of the updated version of the first model, to fall within the at least one predetermined threshold.

19. A non-transitory computer readable medium storing executable instructions for assessing biases of a risk assessment model, wherein the executable instructions, when executed by a processor, configure the processor to:
receive a first model;
generate a first model score output file by evaluating the first model, wherein the first model score output file comprises a first set of ethics and compliance initiative (ECI) information;
transmit the first model score output file to a disparate impact analysis (DIA) service;
utilize the DIA service to:
obtain, from a government monitoring information (GMI) database, first GMI data that corresponds to the first set of ECI information; and
calculate first DIA results by analyzing the first set of ECI information and the first GMI data, wherein the first DIA results comprise a first bias distribution of the first model; and
determine, based on the first DIA results, whether any features of the first model exceed at least one predetermined threshold.

20. The non-transitory computer readable medium of claim 19, wherein the executable instructions further configure the processor to:
utilize the DIA service to determine that at least one of the features of the first model exceeds the at least one predetermined threshold; and
generate at least one recommended change for adjusting the at least one of the features of the first model, to fall within the at least one predetermined threshold.
